(19) United States
(12) Patent Application Publication
(10) Pub. No.: US 2024/0256645 A1
(43) Pub. Date: Aug. 1, 2024

(54) VALIDATION SERVER IN TAPE-BASED BACKUP AND ARCHIVE ENVIRONMENTS

(71) Applicant: International Business Machines Corporation, Armonk, NY (US)

(72) Inventors: Fraser Iain MacIntosh, Reading (GB); Rosanna Lickorish, Southampton (GB)

(73) Assignee: International Business Machines Corporation, Armonk, NY (US)

(21) Appl. No.: 18/102,237

(22) Filed: Jan. 27, 2023

(51) Int. Cl. G06F 21/44

(52) U.S. Cl. CPC G06F 21/44

(57) ABSTRACT

A method for preventing unauthorized access to tape data is disclosed. In one embodiment, such a method includes maintaining, by a validation server, a lock on a tape drive. The method detects loading, by a requesting server, a tape into the tape drive so that it can be written to. The method confirms, using the validation server, that the requesting server is authorized to write to the tape. The method releases, using the validation server, the lock in response to confirming the authorization of the requesting server. In certain embodiments, the validation server is maintained in a separate environment from the requesting server and/or the validation server is not accessible using the same authentication methods used to access the requesting server. A corresponding system and computer program product are also disclosed.

### BACKGROUND

### Field of the Invention

This invention relates to tape storage, and more particularly to systems and methods for securing data backed up or archived on tape storage.

### Background of the Invention

Automated tape libraries are a mainstay of long-term, cost-effective, mass data storage. These systems are used extensively for both data backup and long-term data archive. Tape has been and continues to be one of the most important long-term storage solutions and looks likely to outlive rotational/magnetic disk storage. However, tape systems have up until now been presumed to operate in a trusted environment such that access to tape drives in a tape library presumes trust. This is unfortunately not suitable for modern environments which require zero trust to provide security.

A single tape drive in a tape library has the potential to corrupt up to three thousand tape cartridges per day, with an approximate thirty second load/write/unload cycle. If such a situation were to occur, it would result in catastrophic data loss. It is possible with the majority of and possibly all commercial tape systems to put the data stored on tape beyond reasonable, cost-effective recovery by writing random data over a tape's header, a process that takes seconds. While WORM tape media is available and could not be erased in this manner, this type of media is not suited to backup use cases due to the large amount of media re-use which is required for most data backup and archival systems.

Tape can be duplicated and moved off-site or removed from a library and put “on a shelf.” This is the most resilient method for storing data. However, manually removing and handling tape media is not without risk of loss or damage. Media that is stored in a tape library is also vulnerable to corruption or deletion by means of accidental command malformation or malicious attack.

Presently, there is no mechanism to prevent a user who has gained access to a server from loading a tape into a drive and writing to the drive. This problem is compounded by the fact that most tape drives are maintained in a shared SAN environment, meaning that many servers may access individual tape drives.

### SUMMARY

The invention has been developed in response to the present state of the art and, in particular, in response to the problems and needs in the art that have not yet been fully solved by currently available systems and methods. Accordingly, systems and methods have been developed to prevent unauthorized access to tape data. The features and advantages of the invention will become more fully apparent from the following description and appended claims, or may be learned by practice of the invention as set forth hereinafter.

Consistent with the foregoing, a method for preventing unauthorized access to tape data is disclosed. In one embodiment, such a method includes maintaining, by a validation server, a lock on a tape drive. The method detects loading, by a requesting server, a tape into the tape drive so that it can be written to. The method confirms, using the validation server, that the requesting server is authorized to write to the tape. The method releases, using the validation server, the lock in response to confirming the authorization of the requesting server. The lock is maintained in the event the authorization of the requesting server cannot be confirmed, thereby preventing the requesting server from writing to the tape. In certain embodiments, the validation server is maintained in a separate environment from the requesting server and/or the validation server is not accessible using the same authentication methods used to access the requesting server.

A corresponding system and computer program product are also disclosed and claimed herein.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the embodiments of the invention will be described and explained with additional specificity and detail through use of the accompanying drawings, in which:

FIG. 1 is a high-level block diagram showing one example of a computing system for use in implementing embodiments of the invention;

FIG. 2 is a high-level block diagram showing a system including a validation server that may be used to prevent unauthorized access to tape data;

FIG. 3 is a high-level block diagram showing initial steps that may be taken in the system of FIG. 2 in order to prevent unauthorized access to tape data;

FIG. 4 is a high-level block diagram showing additional steps that may be taken in the system of FIG. 2 in order to prevent unauthorized access to tape data;

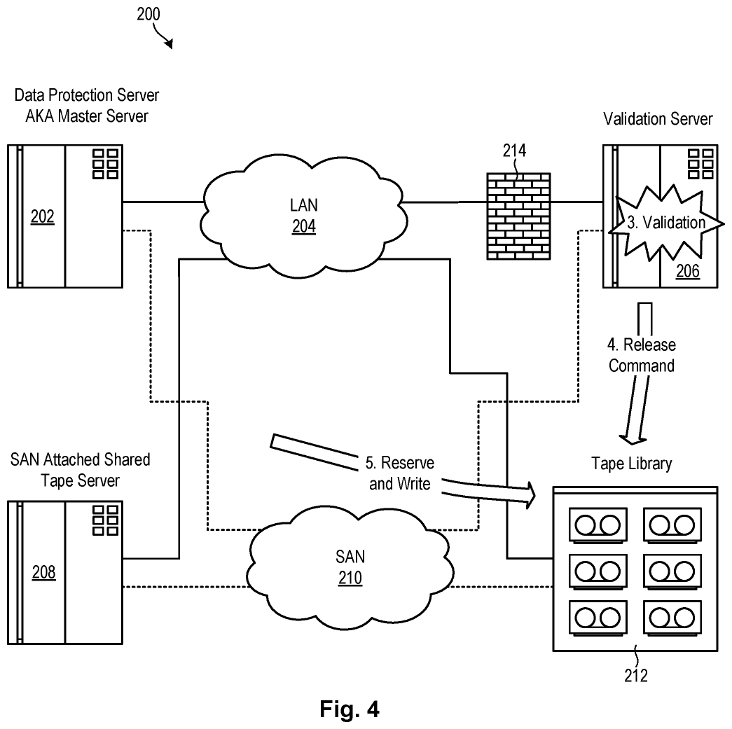

FIG. 5 is a process flow diagram showing one embodiment of a method for preventing unauthorized access to tape data; and

FIG. 6 is a process flow diagram showing one embodiment of a method for monitoring an environment such as that illustrated in FIG. 2 in order to prevent unauthorized access to tape data.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as code 150 to prevent unauthorized access to tape data (i.e., collectively referred to as a “validation module 150”). In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

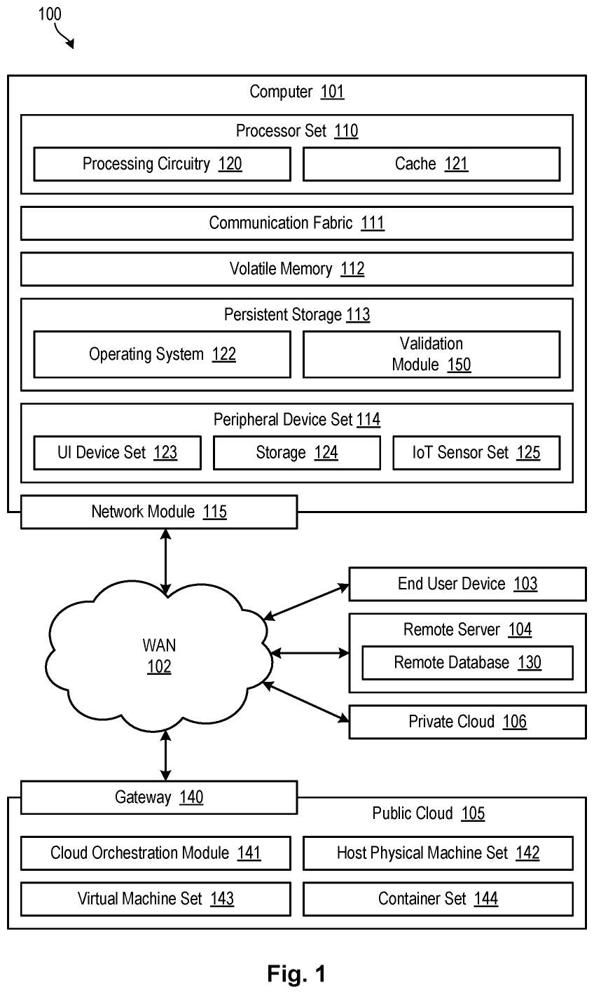

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

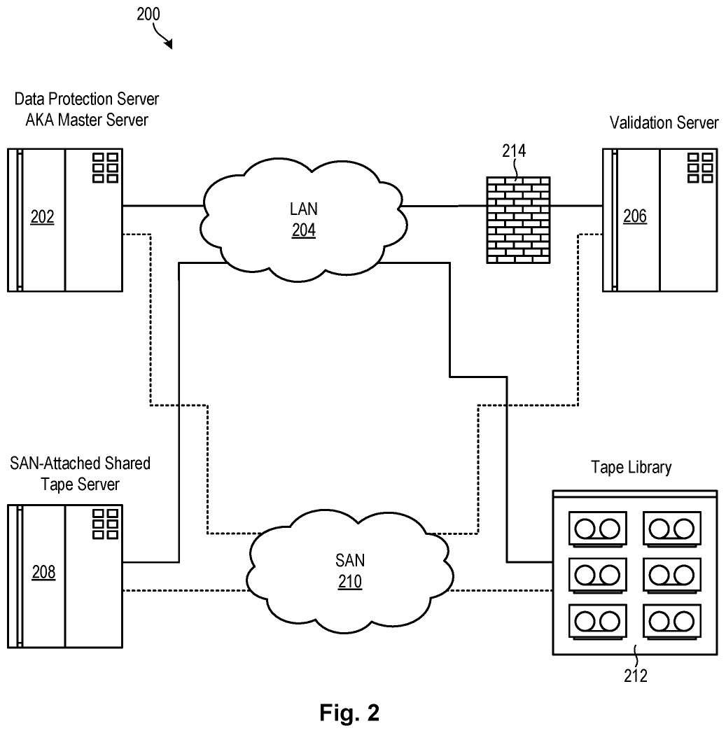

Referring to FIG. 2, one example of a network environment 100 is illustrated. The network environment 100 is presented to show one example of an environment where systems and methods in accordance with the invention may be implemented. The network environment 100 is presented by way of example and not limitation. Indeed, the systems and methods disclosed herein may be applicable to a wide variety of different network environments in addition to the network environment 100 shown.

As shown, the network environment 100 includes one or more computers 102, 106 interconnected by a network 104. The network 104 may include, for example, a local-area-network (LAN) 104, a wide-area-network (WAN) 104, the Internet 104, an intranet 104, or the like. In certain embodiments, the computers 102, 106 may include both client computers 102 and server computers 106 (also referred to herein as “hosts” 106 or “host systems” 106). In general, the client computers 102 initiate communication sessions, whereas the server computers 106 wait for and respond to requests from the client computers 102. In certain embodiments, the computers 102 and/or servers 106 may connect to one or more internal or external direct-attached storage systems 109 (e.g., arrays of hard-storage drives, solid-state drives, tape drives, etc.). These computers 102, 106 and direct-attached storage systems 109 may communicate using protocols such as ATA, SATA, SCSI, SAS, Fibre Channel, or the like.

The network environment 100 may, in certain embodiments, include a storage network 108 behind the servers 106, such as a storage-area-network (SAN) 108 or a LAN 108 (e.g., when using network-attached storage). This network 108 may connect the servers 106 to one or more storage systems, such as arrays 110 of hard-disk drives or solid-state drives, tape libraries 112, individual hard-disk drives 114 or solid-state drives 114, tape drives 116, CD-ROM libraries, or the like. To access a storage system 110, 112, 114, 116, a host system 106 may communicate over physical connections from one or more ports on the host 106 to one or more ports on the storage system 110, 112, 114, 116. A connection may be through a switch, fabric, direct connection, or the like. In certain embodiments, the servers 106 and storage systems 110, 112, 114, 116 may communicate using a networking standard or protocol such as Fibre Channel (FC) or iSCSI.

Referring to FIG. 2, as previously mentioned, automated tape libraries 212 are a mainstay of long-term, cost-effective, mass data storage. These systems 212 are used extensively for both data backup and long-term data archive. Tape has been and continues to be one of the most important long-term storage media and looks likely to outlive rotational/magnetic disk storage. However, tape systems 212 have up until now been presumed to operate in a trusted environment such that access to tape drives in a tape library 212 presumes trust. This is unfortunately not suitable for modern environments which require zero trust to enforce security. A single tape drive in a tape library 212 has the potential to corrupt up to three thousand tape cartridges per day, with an approximate thirty second load/write/unload cycle. Such a situation, if it were to occur, would result in catastrophic data loss.

Presently, there is no mechanism to prevent a user that has gained access to a server from loading a tape into a drive and writing to the drive. This problem is compounded by the fact that most tape drives are maintained in a shared SAN environment, meaning that many servers may access individual tape drives.

FIG. 2 shows one embodiment of a system 200 that may be used to prevent unauthorized access to tape data. This system 200 is presented by way of example and not limitation. The system 200 shown in FIG. 2 is discussed primarily as it relates to data protection (e.g., data backup) although the system 200 may also be used for purposes such as archival, hierarchical storage, or the like. As shown in FIG. 2, in certain embodiments, such a system 200 may include one or more of a data protection server 202, a SAN-attached shared tape server 208, a validation server 206, and a tape library 212 containing one or more tape drives.

The SAN-attached shared tape server 208 may be a component in a data backup infrastructure dedicated to moving data. For example, clients may write into the SAN-attached shared tape server 208 and the SAN-attached shared tape server 208 may then write the data out to tape. The SAN-attached shared tape server 208 may also, in some embodiments, be a very large database server that simply backs up its own data to tape. In general, the data protection server 202 and the SAN-attached shared tape server 208 are both components of a backup environment that have access to a storage area network (SAN) 210 and a tape library 212 in order to back up data to tape.

The tape library 212 may be connected to the storage area network 210 so that it can be shared among the components 202, 206, 208. A local area network (LAN) 204 may be used for command and control and for smaller environments or servers to write data to the data protection server 202 and/or the SAN-attached shared tape server 208, which may then move the data into the storage area network 210 and onto the tape library 212. Smaller environments or smaller components such as virtual machines don't need to write over a storage area network 210, but can rather write over the local area network 204, since doing so may be disproportionately expensive.

Any of the components 202, 206, 208 shown in FIG. 2 may issue a SCSI lock to a tape drive in the tape library 212. This may prevent other components in the system 200 from writing to the tape drive while the lock is in place. As will be explained in more detail hereafter, the validation server 206 may utilize such locks to prevent unauthorized access to tape data in the tape library 212. More specifically, the validation server 206 may place a lock on a tape drive in the tape library 212 and only release the lock after verifying that a requesting server (e.g., the data protection server 202, SAN attached shared tape server 208, or other requesting server) is actually authorized to write to the tape in the tape drive. Thus, the validation server 206 may advantageously use SCSI or other locks to provide an extra layer of security for tape data, effectively converting a trusted environment into a “zero trust” environment that provides more robust data protection.

In certain embodiments, the validation server 206 may be implemented in a secure network segment (e.g., behind a firewall 214) that is separated from the production environment, namely the data protection server 202 and SAN-attached shared tape server 208. Furthermore, the validation server 206 may not be accessible using the same authentication methods that are used in the production environment, such as those authentication methods used to access the data protection server 202, the SAN-attached shared tape server 208, the storage area network 210, and/or the tape library 212. This will prevent users, administrators, or servers that have access to the storage area network 210, tape library 212, data protection server 202, or SAN-attached shared tape server 208 from altering the validation server 206.

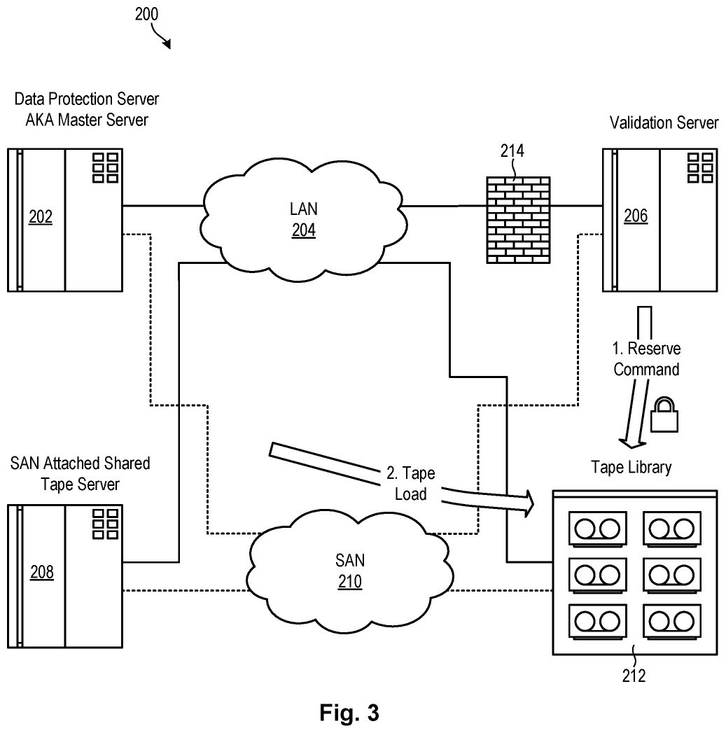

FIG. 3 is a high-level block diagram showing initial steps that may be performed in the system 200 of FIG. 2 in order to prevent unauthorized access to tape data. As shown in FIG. 3, the validation server 206 may have access to all tape drives of the tape library 212 within the SAN environment. When a tape drive appears online in the SAN environment, the validation server 206 may issue a persistent reserve or similar command over the Fibre Channel/SCSI interface to lock access to the tape drive. This may be performed for all tape drives in the tape library 212 and SAN environment.

In addition to a Fibre Channel/SCSI interface, tape drives may also be attached to other types of interfaces, including but not limited to RDMA over Converged Ethernet (ROCE), iSCSI, Parallel SCSI, serial attached SCSI (SAS), and the like. Currently each of these interfaces has some type of reserve command that may be used by the validation server 206 to prevent unauthorized access to tape data. Other interfaces, methods, or techniques for holding access to or lock a tape drive may be available in the future. A “lock” or reserve command as set forth herein is intended to encompass any or all of these interfaces.

As shown in FIG. 3, a server such as the data protection server 202 or SAN-attached shared tape server 208 may issue a command to load a tape into a tape drive that has been locked by the validation server 206. This may be done in preparation to write to the tape. In response, the validation server 206 may take actions to confirm that the requesting server is authorized to write to the tape.

The validation server 206 may assess the validity of tape loads by means including but not limited to, performing a cryptographically signed query against the requesting server or backup software thereon to make sure that the requesting server or software intended to perform the tape load and that the load wasn't maliciously triggered by operating system driver access; and profiling use of the tape drive over time and allowing access to the tape drive if the access has been requested within certain bounds based on frequency, time of day, etc. Further security features such as periodic querying of a tape library 212 to establish how many drives it contains, statistical analysis of tape loads, tape load frequency and duration may all be considered by the validation server 206 when ascertaining the validity of a tape load. In certain embodiments, automated tests may be provided by plugins from external attack detection systems, which may trigger alerts to prevent operations that may be caused by an attack. As previously discussed, the validation server 206 may be isolated or separated from the requesting server due to the potential for the requesting server to be compromised and as a result perform tape loads and erase or modify tape data.

Once the validation server 206 has confirmed that the requesting server is authorized to write to the tape, the validation server 206 may send a release command to the tape library 212 and thereby release the lock that it has on the tape drive. This may allow the requesting server to write to the tape that has been loaded into the tape drive. Once the requesting server has written to and ejected the tape as well as released the lock, the lock may be reacquired by the validation server 206.

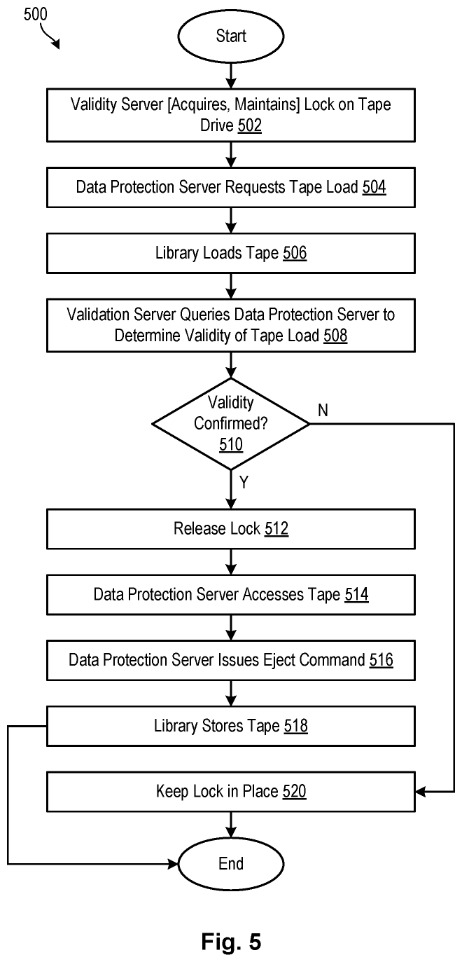

Referring to FIG. 5, a process flow diagram showing one embodiment of a method 500 for preventing unauthorized access to tape data is illustrated. As shown, the validation server 206 initially acquires 502 a lock on a tape drive of a tape library 212. The data protection server 202 then requests 504 to load a tape into the tape drive and the tape library 212 loads 506 the tape in response to the request. The validation server 206 then queries 508 the data protection server 202 to determine 508 the validity of the tape load. If the validity of the tape load is confirmed at step 510, the validation server 206 releases 512 the lock on the tape drive. If the validity of the tape load cannot be confirmed, the validation server 206 keeps 520 the lock in place.

If the validity of the tape load is confirmed, the validation server 206 releases 512 the lock and the data protection server 202 is allowed to access 514 (i.e., read or write) to the tape. Once the data protection server 202 has completed its access, the data protection server 202 issues 516 an eject command and the tape library 212 stores 518 the tape. The method 500 then ends. Once the data protection server 202 has released the lock and ejected the tape, the validation server 206 may reacquire the lock on the tape drive in order to mediate the next attempted access to tape by way of the tape drive. It should be noted that the method 500 is not limited to use with the recited data protection server 202 but may also be used with other requesting servers.

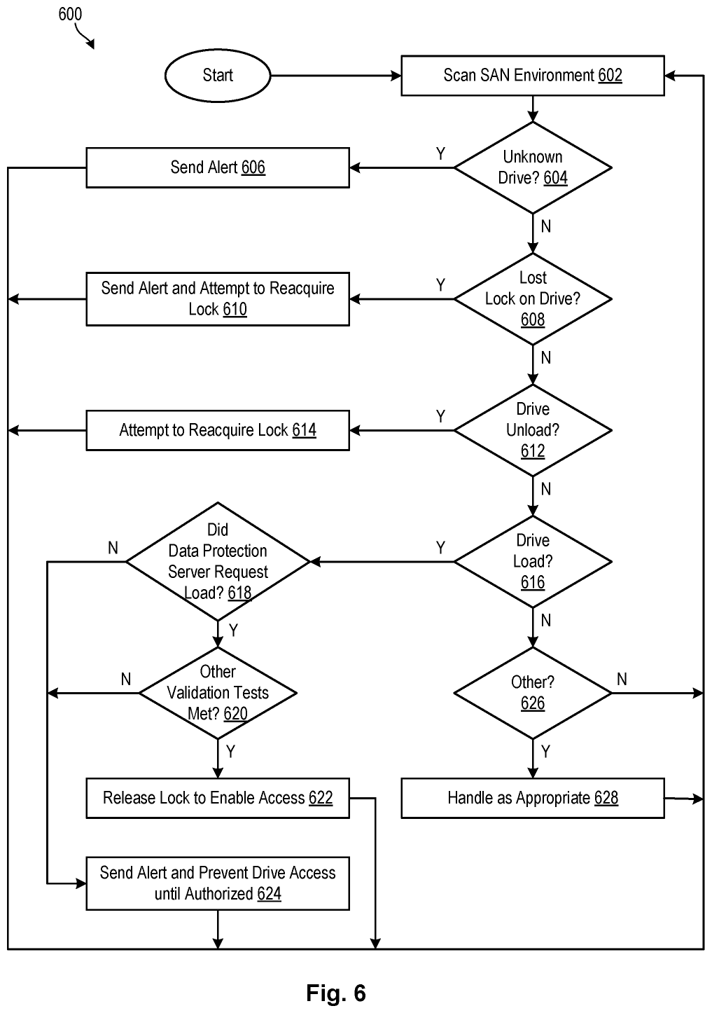

Referring to FIG. 6, in certain embodiments, the validation server 206 may also be configured to perform general monitoring of the SAN environment to prevent unauthorized access to tape data, in addition to mediating attempts to write to tape by way of a tape drive.

FIG. 6 is a process flow diagram showing one embodiment of a method 600 for monitoring an environment such as that illustrated in FIG. 2 in order to prevent unauthorized access to tape data. As shown, the validation server 206 may periodically scan 602 the SAN environment. If, at step 602, the validation server 206 detects 604 an unknown tape drive in the SAN environment, the validation server 206 may send 606 an alert to a system administrator to inform the system administrator of the unrecognized tape drive so that the system administrator can take appropriate action.

The validation server 206 may also in certain embodiments scan for lost locks in the SAN environment. If, at step 608, the validation server 206 detects 608 that a lock has been lost on one of the tape drives in the SAN environment, the validation server 206 may alert 610 a system administrator and attempt 610 to reacquire the lock. A lock may be lost for various reasons, including a power outage or shutdown of the validation server 206. While the lock is lost, the tape drive may be at greater risk of unauthorized access. In such cases, the validation server 206 may attempt to reacquire the lock as soon as possible using any known technique.

The validation server 206 may also scan the SAN environment for tape drives that have had tapes unloaded therefrom. This may occur, for example, when a requesting server is finished accessing data on tape and the tape has been unloaded from the tape drive and any lock has been released. If, at step 612, the validation server 206 detects 612 that a tape has been unloaded from a tape drive in the SAN environment, the validation server 206 may attempt to reacquire a lock on the tape drive to prevent unauthorized access to tape data.

The validation server 206 may also, as previously discussed, detect when a tape has been loaded into a tape drive. If, at step 616, the validation server 206 detects such a tape load, the validation server 206 may determine 618 whether the data protection server 202 (i.e., the requesting server) requested the tape load. If the data protection server 202 did not request the tape load, the validation server 206 may send 624 an alert to a system administrator and prevent 624 access to the tape drive until authorized. This may be accomplished by retaining the lock on the tape drive.

If, on the other hand, the data protection server 202 was determined to have requested the tape load at step 618, the validation server 206 may determine 620 whether other validations tests are satisfactory 620. These other validation tests may include, for example, determining whether the tape drive is experiencing an unusual load rate, determining whether tape in the tape drive was used in an unusually quick manner, determining whether behavior is occurring with a tape drive that is outside of or strays from an observed pattern, or the like. If any of these other tests fail at step 620, the validation server 206 may send 624 an alert to a system administrator and prevent 624 tape drive access until authorized.

On the other hand, if both tests 618, 620 are satisfied, meaning the data protection server 202 did request the tape load and any other validation tests are satisfied, the validation server 206 releases 622 the lock on the tape drive to enable access to the tape by the requesting server.

The validation server 206 may, at step 626, scan for a variety of other conditions which may be indicative of an invalid tape load in the SAN environment. If any such conditions are detected, the validation server 206 may handle 628 as appropriate. Otherwise, the method 600 may return to the top where the validation server 206 may once again scan 602 the SAN environment.

One of the advantages of the system 200 disclosed herein is that it may require very little modification to an existing storage area network 210 or tape backup infrastructure. For example, little or no modification may be required to the data protection server 202 and/or SAN-attached shared tape server 208 to implement the validation server 206 shown in FIG. 2. The server software of the data protection server 202 and SAN-attached shared tape server 208 may, in certain embodiments, be modified to include an interface to receive queries from the validation server 206 to confirm tape loads. Such an interface may already effectively be present with secure access to server logs.

The flowcharts and block diagrams in the Figures illustrate the architecture, functionality, and operation of possible implementations of systems, methods, and computer program products according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other implementations may not require all of the disclosed steps to achieve the desired functionality. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

1. A method for preventing unauthorized access to tape data, the method comprising:
maintaining, by a validation server, a lock on a tape drive;
detecting, by the validation server, loading of a tape into the tape drive for writing by a requesting server;
confirming, by the validation server, that the requesting server is authorized to write to the tape; and
releasing, by the validation server, the lock in response to confirming authorization of the requesting server.

2. The method of claim 1, wherein the validation server is maintained in a separate environment from the requesting server.

3. The method of claim 1, wherein the validation server is not accessible using the same authentication methods used to access the requesting server.

4. The method of claim 1, wherein the tape drive is located within a SAN environment.

5. The method of claim 1, wherein the tape drive is accessible through an interface selected from the group consisting of RDMA over Converged Ethernet (RoCE), Parallel SCSI, and Serial Attached SCSI (SAS).

6. The method of claim 1, wherein maintaining the lock on the tape drive comprises generating the lock in response to detecting the tape drive coming online.

7. The method of claim 1, wherein the lock prevents access to the tape drive by the requesting server.

8. A computer program product for preventing unauthorized access to tape data, the computer program product comprising a computer-readable storage medium having computer-usable program code embodied therein, the computer-usable program code configured to perform the following when executed by at least one processor:
maintain, by a validation server, a lock on a tape drive;
detect, by the validation server, loading of a tape into the tape drive for writing by a requesting server;
confirm, by the validation server, that the requesting server is authorized to write to the tape; and
release, by the validation server, the lock in response to confirming authorization of the requesting server.

9. The computer program product of claim 8, wherein the validation server is maintained in a separate environment from the requesting server.

10. The computer program product of claim 8, wherein the validation server is not accessible using the same authentication methods used to access the requesting server.

11. The computer program product of claim 8, wherein the tape drive is located within a SAN environment.

12. The computer program product of claim 8, wherein the tape drive is accessible through an interface selected from the group consisting of: RDMA over Converged Ethernet (RoCE), Parallel SCSI, and Serial Attached SCSI (SAS).

13. The computer program product of claim 8, wherein maintaining the lock on the tape drive comprises generating the lock in response to detecting the tape drive coming online.

14. The computer program product of claim 8, wherein the lock prevents access to the tape drive by the requesting server.

15. A system for preventing unauthorized access to tape data, the system comprising:
at least one processor;
at least one memory device operably coupled to the at least one processor and storing instructions for execution on the at least one processor, the instructions causing the at least one processor to:
maintain, by a validation server, a lock on a tape drive;
detect, by the validation server, loading of a tape into the tape drive for writing by a requesting server;
confirm, by the validation server, that the requesting server is authorized to write to the tape; and
release, by the validation server, the lock in response to confirming authorization of the requesting server.

16. The system of claim 15, wherein the validation server is maintained in a separate environment from the requesting server.

17. The system of claim 15, wherein the validation server is not accessible using the same authentication methods used to access the requesting server.

18. The system of claim 15, wherein the tape drive is located within a SAN environment.

19. The system of claim 15, wherein maintaining the lock on the tape drive comprises generating the lock in response to detecting the tape drive coming online.

20. The system of claim 15, wherein the lock prevents access to the tape drive by the requesting server.
